(19) United States
(12) Patent Application Publication
(10) Pub. No.: US 2015/0079301 A1
(43) Pub. Date: Mar. 19, 2015

(54) METHOD OF DEPOSITING THIN METAL-ORGANIC FILMS

(71) Applicants: Srinivas NEMANI, Sunnyvale, CA (US); Ellie YIEH, San Jose, CA (US); Dmitry LUBOMIRSKY, Cupertino, CA (US)

(72) Inventors: Srinivas NEMANI, Sunnyvale, CA (US); Ellie YIEH, San Jose, CA (US); Dmitry LUBOMIRSKY, Cupertino, CA (US)

(21) Appl. No.: 14/067,851

(22) Filed: Oct. 30, 2013

Related U.S. Application Data
(60) Provisional application No. 61/877,724, filed on Sep. 13, 2013.

(51) Int. Cl. B05D 1/02; B05C 5/02; B05D 3/06

(52) U.S. Cl. CPC B05D 1/02; B05D 3/067; B05C 5/0291
USPC 427/508; 427/294; 118/300; 118/323; 118/620

(57) ABSTRACT

Embodiments include systems, apparatuses, and methods of thin metal-organic film deposition with inkjet printheads. A method of depositing a metal-organic thin film over a substrate includes introducing chemical precursors into one or more piezoelectric printheads. The chemical precursors including a metallic compound and a reactive liquid or gas. The method further includes dispensing droplets or a stream of the chemical precursors with the piezoelectric printheads onto a surface of the substrate supported by a stage in a vacuum chamber.

### PRIORITY

This application claims the benefit of priority to U.S. Provisional Application No. 61/877,724 filed on Sep. 13, 2013, titled “METHOD OF DEPOSITING THIN METAL-ORGANIC FILMS,” the entire contents of which is hereby incorporated by reference in its entirety for all purposes.

### BACKGROUND

1) Field

Embodiments of the present invention pertain to the field of deposition of thin films, in particular, to deposition of thin metal-organic films with printheads.

2) Description of Related Art

Conventional methods of depositing dielectric films include spin-coating, which involves coating a wafer or substrate with a liquid material by a spin-coating machine. A spin-coating machine may include a spin track that holds and rotates the wafer or substrate, and a nozzle at the center of the spin track that dispenses the liquid material. The spin-coating machine rotates the wafer or substrate, and thus distributes the material throughout the wafer surface by centrifugal force.

In spin-coating methods, the viscosity of the liquid dispensed affects the thickness of the film as well as uniformity of the film across the wafer. Thus, spin-coating methods typically involve the use of a solvent to control the viscosity of the liquid material dispensed, and therefore to control the thickness and uniformity of the film. Some materials, such as compounds with high metallic concentrations, typically cannot be applied uniformly and with the desired thickness by spin-coating because of the high viscosity and short “shelf-life” of the materials. For example, the soluble inorganic-organic compounds for forming metal oxide and metal nitride masks have a short shelf-life and high viscosity. Spin-coating a wafer or substrate with such materials can result in a high rate of defects, and/or edge bead formation. Edge beads are beads or a lip at or near the edge of the wafer formed by the collection of the dispensed material.

Thus, existing methods of deposition lack the ability to deposit uniform thin metal-organic films. Furthermore, spin-coating typically results in substantial chemical waste (e.g., 99% waste).

### SUMMARY

One or more embodiments of the invention are directed to deposition of metal-organic films with inkjet printheads.

In one embodiment, a method of depositing a metal-organic thin film over a substrate includes introducing chemical precursors into one or more piezoelectric printheads. The chemical precursors include a metallic compound and a reactive liquid or gas. The method further includes dispensing droplets or a stream of the chemical precursors with the piezoelectric printheads onto a surface of the substrate supported by a stage in a vacuum chamber.

In one embodiment, a piezoelectric printhead to deposit a thin film over a substrate includes a compartment to receive a chemical precursor including one or more of a metallic compound and a reactive liquid or gas. The printhead further includes a nozzle to dispense the chemical precursor. The nozzle has an opening with an adjustable size to dispense droplets of the chemical precursor of different sizes or a continuous stream of the chemical precursor. The printhead further includes a piezoelectric component coupled with the nozzle to force the chemical precursor from the compartment to the nozzle, dispensing the chemical precursor over a surface of the substrate.

In one embodiment, a system to deposit a thin film over a substrate includes a processing chamber and a stage to support a substrate in the processing chamber. The system includes one or more piezoelectric printheads to dispense one or more chemical precursors in droplets or a stream over the substrate. The system further includes a chemical precursor source to deliver the one or more chemical precursors including a metallic compound and a reactive liquid or gas to the one or more piezoelectric printheads.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIGS. 1a and 1b illustrate systems to perform metal-organic thin film deposition with one or more piezoelectric printing heads, in accordance with an embodiment of the present invention.

FIGS. 2a and 2b illustrate plan views of the stage and printheads of FIGS. 1a and 1b to perform metal-organic thin film deposition, in accordance with an embodiment of the present invention.

FIG. 3 is a flow diagram of a method of depositing a metal-organic thin film with one or more piezoelectric printing heads, in accordance with an embodiment of the present invention.

FIG. 4 illustrates a block diagram of an exemplary computer system within which a set of instructions, for causing the computer system to perform any one or more of the methodologies discussed herein, may be executed.

### DETAILED DESCRIPTION

Apparatuses, systems, and methods of depositing thin films, such as metal-organic films are described.

Embodiments include one or more “inkjet” printheads in a processing chamber to dispense droplets or a flow of liquid over a substrate or semiconductor wafer to form a uniform thin film. One embodiment includes an array of inkjet printheads. Inkjet printheads include printheads with one or more piezoelectric devices capable of dispensing precise droplets or a continuous stream of a liquid material. The printheads can dispense droplets having a precise size, for example, in the range of approximately 30-500 μm. Other printheads may dispense droplets having a smaller or larger size. In one embodiment, a printhead controller can adjust the printhead nozzle opening to dispense larger or smaller droplets.

In an embodiment with more than one printhead, the system can introduce different chemistries into different printheads. The printheads can separately dispense the different chemistries, and the different chemistries can mix on the substrate or wafer. Separately dispensing different chemistries can minimize shelf-life issues by keeping reactive components separate until mixed on the substrate or wafer. Keeping chemistries separate until after dispensing also avoids the precipitation of defects seen in solutions used in spin-coating.

According to an embodiment, the semiconductor wafer or substrate is supported over a stage in a chamber. The chamber may include a vacuum chamber. The chamber volume can be smaller than typical spin-coating chambers, which can enable an inert atmosphere and minimize moisture in the chamber. The stage and/or the printhead(s) can move or rotate to uniformly dispense the liquid to form the film. For example, the wafer can be moved in a line or rotated below the printhead array according to uniformity requirements and the material deposited. The uniformity of the deposited film is determined by, for example, the viscosity of the dispensed liquid, the speed of movement and/or rotation, and the size of the printhead nozzle opening. In one embodiment, a stage includes one or more heaters, which can accelerate reactions of the chemical precursors on the wafer or substrate.

Embodiments can further include a curing mechanism such as a UV lamp, electron beam (e-beam) mechanism, plasma source, or heater for in-situ curing. Performing a curing method after dispensing the liquid via the printheads can provide for stability control and prevent issues related to aging.

Thus, embodiments enable deposition of a uniform layer over a substrate or semiconductor wafer. Printheads can dispense precursors for forming metal-organic films at a microscopic level for precise thickness and uniformity control without the edge beads and defects associated with spin-coating. Therefore, embodiments do not require an additional edge bead removal step, which can be necessary in spin-coating methods. In the case of deposition over a semiconductor wafer, the printheads can enable precise control of the amount of material dispensed at each die on the wafer. The printheads may dispense materials having varying viscosities, including high viscosity materials such as high metallic materials, unlike spin-coating machines. Thus, embodiments of the invention enable deposition of metal oxide masks from liquid precursors using the printheads. Metal oxide hard masks have a high etch selectivity, enabling higher aspect ratio etching.

Furthermore, embodiments can minimize waste of chemical precursors. For example, embodiments can result in less than ˜2% waste, which is substantially less than typical spin-coating methods, which, as mentioned above, can result in chemical waste of ˜99%. The small amount of chemical precursors used can reduce costs and also enable longer shelf-life due to easier and less expensive vacuum storage.

In the following description, numerous specific details are set forth, such as specific curing methods, in order to provide a thorough understanding of embodiments of the present invention. It will be apparent to one skilled in the art that embodiments of the present invention may be practiced without these specific details. In other instances, well-known aspects, such as specific chemical precursors for generating thin films and curing techniques, are not described in detail in order to not unnecessarily obscure embodiments of the present invention. Furthermore, it is to be understood that the various embodiments shown in the Figures are illustrative representations and are not necessarily drawn to scale.

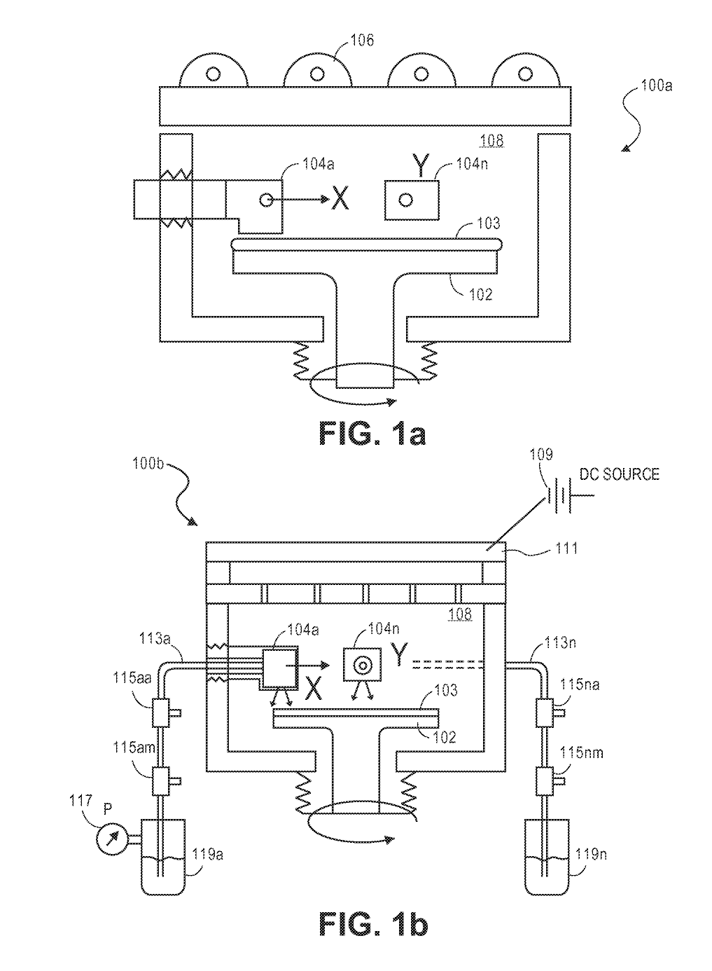

FIGS. 1a and 1b illustrate systems to perform film deposition with one or more printheads, in accordance with an embodiment of the present invention. The system 100a of FIG. 1a and the system 100b of FIG. 1b each include a chamber 108 equipped with a sample holder 102 (also referred to as a stage). The chamber 108 may include a processing chamber such as a vacuum chamber suitable for deposition of reactive chemistries. One or more printheads 104a-104n dispense droplets or a stream (e.g., continuous flow) of a material over a substrate or semiconductor wafer 103 held by the sample holder 102.

The sample holder 102 may include a sample positioning device suitable to bring a sample (e.g., the substrate or semiconductor wafer 103) in proximity to the droplets or stream of material dispensed by the printhead(s) 104a-104n. The sample holder 102 and/or the printhead(s) 104a-104n may be a movable, tiltable, and/or rotatable. Moving the relative positions of the stage with respect to the printhead(s) laterally, vertically, and/or at an angle enables uniform deposition of a thin film with the desired thickness. The systems 100a and 100b illustrate one arrangement including one printhead 104a that moves along an x-axis (as indicated by the arrows in FIGS. 1a and 1b), and a second printhead 104n that moves along a y-axis (e.g., along an axis normal to the page).

In one embodiment, the systems 100a and 100b can rotate the stage 102 to dispense material through non-centrally located printhead(s) 104a-104n. In one such embodiment, one or more printhead(s) 104a-104n are stationary for one or more revolutions of the stage 102 until the desired thickness in a particular section (e.g., a circular section), is achieved. The systems 100a and 100b then move the one or more printhead(s) 104a-104n and/or stage 102 to a new position, and rotate the stage 102 to deposit the material in the next section(s). For example, the systems 100a and 100b may begin depositing material with the printhead(s) 104a-104n at the edge of the substrate or semiconductor wafer 103 and rotating the stage 102. The systems 100a and 100b can then move the printhead(s) 104a-104n inward towards the middle of the substrate or semiconductor wafer 103 and rotate the stage 102 again. The systems 100a and 100b can repeat this process multiple times until the material is uniformly deposited. In another embodiment, the systems 100a and 100b can start depositing at the center of the substrate or semiconductor wafer 103, and move outwards towards the edge of the substrate or semiconductor wafer 103. In one embodiment employing a rotatable stage 102, the spinning speed of the stage 102 is substantially slower than typical spin-coating. For example, in one embodiment, the stage 102 spins slower than 100 rpm. Thus, the spinning can enable deposition throughout the semiconductor wafer or substrate 103 without generating edge beads like in spin-coating. Spinning the stage 102 can also improve mixing and/or uniformity of the dispensed chemical precursors.

The systems 100a and 100b may employ other patterns of movement of the printhead(s) 104a-104n and/or stage 102 than those described above. For example, in one embodiment, the systems 100a and 100b can move the stage 102 in a line to evenly dispense the chemical precursors across the semiconductor wafer or substrate 103. For example, the systems 100a and 100b can move the stage 102 in a direction perpendicular to an array of printheads. Embodiments can include both spinning the stage 102 and movement in a vertical or horizontal direction with respect to the printhead(s) 104a-104n.

As illustrated in FIGS. 1a and 1b, the one or more printheads 104a-104n include multiple printhead nozzles next to each other (e.g., configured as a printhead array). For example, embodiments may include two, three, or more printheads 104a-104n.

In embodiments with multiple printheads, the printheads can dispense multiple chemistries. For example, the printheads 104a-104n can dispense two or three different chemistries which react on the wafer surface to form the thin film. FIG. 1b illustrates the system 100b, which includes such a mechanism for dispensing multiple chemistries with the printheads 104a-104n. The system 100b includes precursor sources 119a-119n, which can include different chemical precursors. For example, the precursor source 119a can contain a metallic compound such as an aluminum based compound and another precursor source 119n can include peroxide or another reactive liquid or gas.

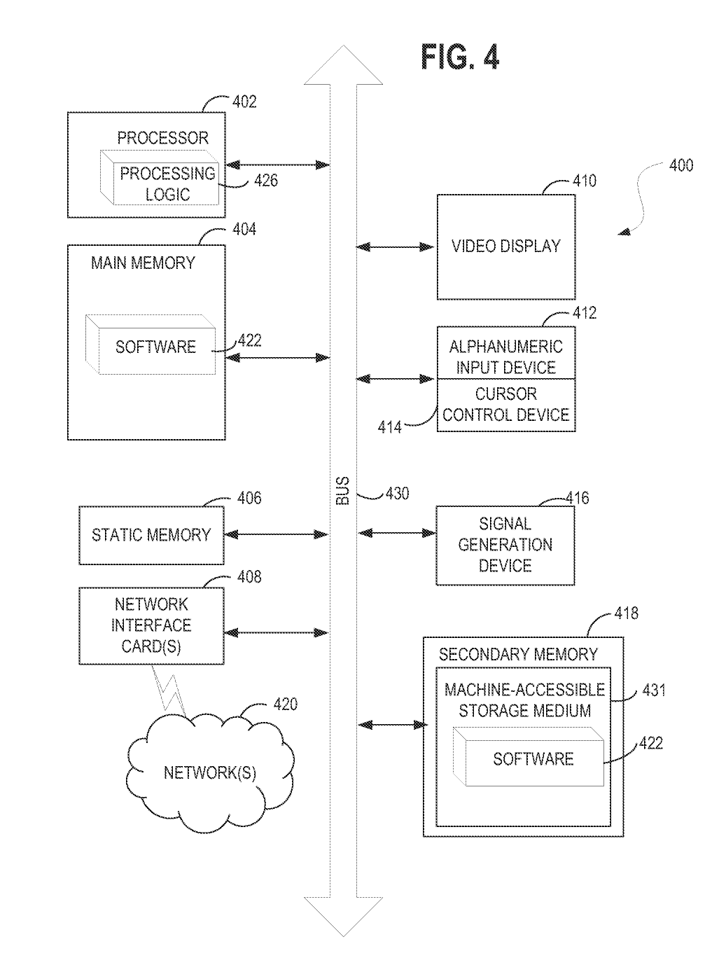

The system 100b includes tubes 113a-113n or other mechanisms for liquid delivery, and flow control mechanisms 115aa-115nm for controlling delivery and flow of the precursors from the precursor sources 119a-119n to the printheads 104a-104n. The system 100b further includes a pressurizing valve 117 for constant liquid delivery to the corresponding printhead. The flow control mechanisms 115aa-115nm can include liquid flow meters (LFMs) to detect the volumetric flow rate of the precursors being delivered to the printheads 104a-104n. One or more controllers (not shown) are coupled with the systems 100a and 100b to control the deposition of chemical precursors. The controller(s) can include a computing system such as the system 400 of FIG. 4, or any other suitable controller or computing system. One or more controllers can control the flow rate of the precursors and/or the nozzle opening size of the printhead(s) 104a-104n, according to an embodiment. Thus, the controller(s) can control whether the printhead(s) 104a-104n dispense discrete droplets of the precursors or a continuous flow of the precursors. The controller can adjust the size of the nozzle opening of the printhead(s) 104a-104n to dispense droplets with a size ranging from approximately 30 μm to 500 μm (e.g., droplets with a diameter of approximately 30 μm to 500 μm). In one embodiment, the printhead(s) dispense droplets with a size of approximately 40 μm. The controller can control the printhead(s) 104a-104n independently such that one printhead dispenses droplets of one material, while another printhead dispenses a continuous stream of another material.

Returning to the example mentioned above where one precursor source 119a contains a metallic compound and another of the precursor sources contains a different compound such as a reactive liquid or gas, the printhead 104a would dispense the metallic compound, and printhead 104n would dispense the reactive liquid or gas. In one such example, the printhead 104a dispenses and aluminum based compound and the printhead 104n dispenses hydrogen peroxide. In contrast to existing methods such as spin-coating, which mix compounds prior to dispensing, the systems 100a and 100b keep the compounds separate until after the printheads 104a and 104n dispense the materials. The dispensed materials would then mix on the surface of the wafer or substrate 103 to form aluminum oxide over the wafer or substrate.

The printheads 104a-104n may also dispense other combinations of metal-organic precursors and oxidizers or other reactors to form metal-organic layers, such as a metal oxide or metal nitride layer over the semiconductor wafer or substrate 103. For example, chemical precursors may include Zirconium tetrakis(t-butoxide) ZTTB and a reactive liquid or gas such as oxygen (O₂), hydrogen peroxide (H₂O₂), or ozone (O₃). In one embodiment, one printhead performs alumina deposition by dispensing aluminum acetylacetonate (Al(acac)₃), while another printhead dispenses ozone or hydrogen peroxide. In one such embodiment, the stage is heated to aid the reaction of the separately dispensed chemical precursors.

Returning to FIG. 1a, the system 100a of FIG. 1a includes ultraviolet (UV) and/or infrared (IR) sources 106 for curing a metal-organic layer formed over the substrate or wafer 103. In another embodiment, as illustrated in FIG. 1b, the system 100b includes a DC source 109 and cathode 111 for e-beam generation to cure the metal-organic layer. In one embodiment with e-beam curing, electrons are generated with a plasma and accelerated to the wafer surface by providing an accelerating voltage to a showerhead. Some embodiments include plasma processing mechanisms for curing. In one such embodiment, the chamber includes a gas inlet device, an evacuation device, a plasma ignition device, and a detection device. The evacuation device may be a device suitable to evacuate and de-pressurize chamber 108. A gas inlet device may be a device suitable to inject a reaction gas into chamber 108. A plasma ignition device may be a device suitable for igniting a plasma derived from the reaction gas injected into chamber 108 by gas inlet device. A detection device may be a device suitable to detect an end-point of a processing operation. In one embodiment, systems 100a and 100b include a chamber 108, a sample holder 102, an evacuation device, a gas inlet device, a plasma ignition device and a detector similar to an etch chamber, such as the etch chamber used on an Applied Materials® AdvantEdge system.

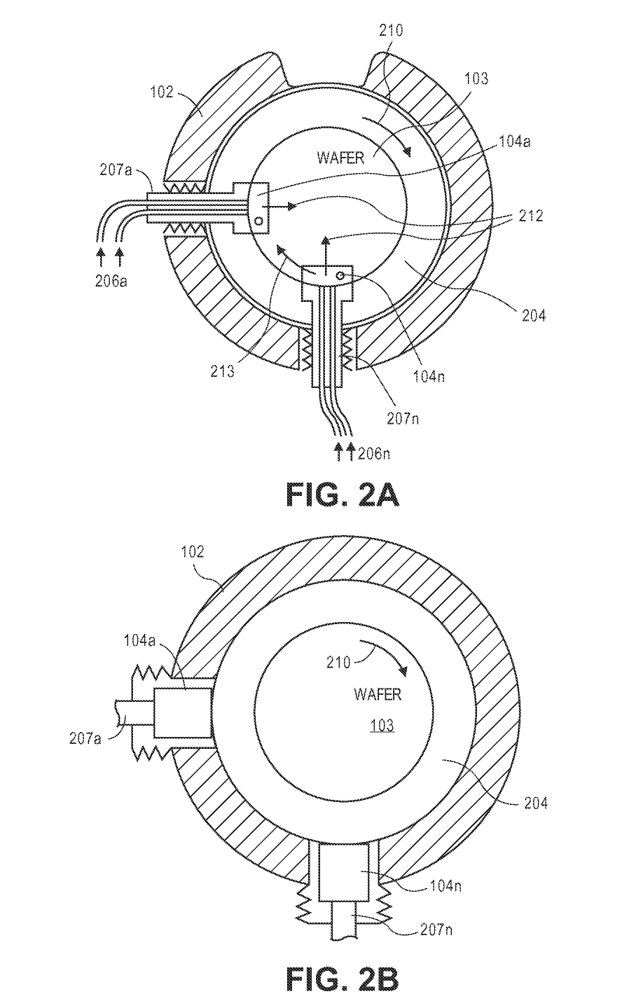

FIGS. 2a and 2b illustrate plan views of the stage 102 and printhead(s) 104a-104n of systems 100a and 100b of FIGS. 1a and 1b, in accordance with an embodiment of the present invention. The top-down views illustrated in FIGS. 2a and 2b include the wafer or substrate 103 held by the stage 102. The arrow 210 indicates that the stage 102 is rotating, and therefore the semiconductor wafer 103 is also rotating, as indicated by the arrow 213. The views in FIGS. 2a and 2b also show the printheads 104a-104n located at the end of dispenser arms 207a-207n. Each of the dispenser arms 207a-207n can support and move one or more printheads 104a-104n. In one example, each of the dispenser arms 207a-207n supports an array of printheads. As illustrated in FIG. 2a, the dispenser arms 207a-207n are in a partially retracted position. The dispenser arms 207a-207n can be either partially or fully retracted for pre- or post-deposition treatment with, for example, a top source assembly. Arrows 212 in FIG. 2a illustrate exemplary directions in which the dispenser arms with the printheads 104a-104n can move. Arrows 206a-206n indicate chemical precursors being delivered to the printheads 104a-104n. A pumping or drain plenum 204 removes excessive material dispensed by the printheads 104a-104n.

FIG. 2b illustrates an exemplary plan view after deposition of the thin film. The dispenser arms 207a-207n in FIG. 2b are in a fully retracted position (e.g., flush with the chamber wall). The retraction of the dispenser arms 207a-207n allows for post-processing such as curing via ultraviolet (UV) sources, infrared (IR) sources, plasma, or electron beam (e-beam) treatment. Although FIGS. 1a, 1b, 2a, and 2b show two printheads, any number of printheads may be used. For example, systems may include a single printhead, two, three, or more than three printheads. As indicated above, printheads can be arranged in arrays with multiple printheads. Printheads may be located at different areas above the stage, and therefore above the wafer or substrate.

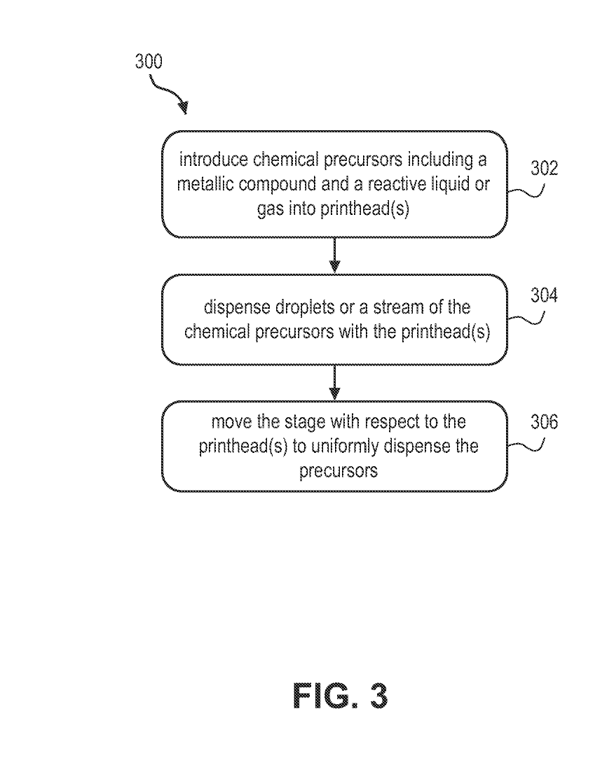

FIG. 3 is a flow diagram of a method 300 of depositing a metal-organic thin film with one or more piezoelectric printing heads, in accordance with an embodiment of the present invention. Deposition systems including printhead(s) such as the systems 100a and 100b can perform the method 300 of depositing a metal-organic film. The method 300 begins with the system introducing chemical precursors into one or more printhead(s) (e.g., the printheads 104a-104n of FIGS. 1a and 1b), at operation 302. In an embodiment with a plurality of printheads, operation 302 may involve introducing different chemical precursors into the plurality of printheads. For example, the system introduces one chemical precursor into one of the printheads, and a second chemical precursor into a second printhead.

The system dispenses droplets or a continuous stream of the precursors with the printhead(s) at operation 304. In an embodiment with multiple printheads, one of the plurality of printheads dispenses one chemical precursor (e.g., a metal compound such as an aluminum-based compound), and another of the printheads dispenses another chemical precursor (e.g., a reactive liquid or gas such as hydrogen peroxide). According to an embodiment, the system can adjust the size of the opening of nozzles of one or more printheads to adjust the size of the droplets or stream dispensed over the substrate.

The system moves the stage with respect to the printhead(s) to uniformly dispense the precursors at operation 306. According to an embodiment, moving the stage involves moving the stage horizontally, moving the stage vertically, rotating the stage, and/or tilting the stage with respect to the printhead(s). In one embodiment moving the stage involves moving the stage in a line perpendicular to an array of printheads. The method can also include moving the printhead(s) with respect to the stage, instead of, or in addition to, moving the stage. For example, the method can involve moving the printhead(s) horizontally, moving the printhead(s) vertically, rotating the printhead(s), and/or tilting the printhead(s) with respect to the stage.

The method can further involve curing the layer of the dispensed material. For example, the system can cure the layer by irradiating the layer with a UV lamp, heating the substrate with a heater, plasma processing, electron beam (e-beam) curing, or any other technique for curing the film. Thus, the system can form a uniform mask over a substrate or semiconductor.

FIG. 4 illustrates a computer system 400 within which a set of instructions, for causing the machine to execute one or more of the scribing methods discussed herein may be executed. Some or all of the components of system 400 may be included in a controller, as described above, to control printheads to dispense precursors to form metal-organic films over a substrate or semiconductor wafer. The exemplary computer system 400 includes a processor 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a secondary memory 418 (e.g., a data storage device), which communicate with each other via a bus 430.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, etc. Processor 402 may also be one or more special-purpose processing devices such as an application specific integrated circuit (ASIC), a field programmable gate array (FPGA), a digital signal processor (DSP), network processor, or the like. Processor 402 is configured to execute the processing logic 426 for performing the operations and steps discussed herein.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The secondary memory 418 may include a machine-accessible storage medium (or more specifically a computer-readable storage medium) 431 on which is stored one or more sets of instructions (e.g., software 422) embodying any one or more of the methodologies or functions described herein. The software 422 may also reside, completely or at least partially, within the main memory 404 and/or within the processor 402 during execution thereof by the computer system 400, the main memory 404 and the processor 402 also constituting machine-readable storage media. The software 422 may further be transmitted or received over a network 420 via the network interface device 408.

While the machine-accessible storage medium 431 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention.

For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

Thus, embodiments include methods and systems for deposition of materials over a substrate or wafer with printheads to form a metal-organic thin film over the substrate or wafer.

It is to be understood that the above description is intended to be illustrative, and not restrictive. For example, while flow diagrams in the figures show a particular order of operations performed by certain embodiments of the invention, it should be understood that such order is not required (e.g., alternative embodiments may perform the operations in a different order, combine certain operations, overlap certain operations, etc.). Furthermore, many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. The scope of the invention should, therefore, be determined with reference to the appended claims, along with the full scope of equivalents to which such claims are entitled.

What is claimed is:

1. A method of depositing a metal-organic thin film over a substrate, the method comprising:
introducing chemical precursors into one or more piezoelectric printheads, the chemical precursors including a metallic compound and a reactive liquid or gas;
dispensing droplets or a stream of the chemical precursors with the one or more piezoelectric printheads onto a surface of the substrate supported by a stage in a vacuum chamber.

2. The method of claim 1, further comprising:
moving the stage with respect to the one or more printheads.

3. The method of claim 2, wherein moving the stage with respect to the one or more printheads comprises one or more of:
moving the stage horizontally, moving the stage vertically, rotating the stage, and tilting the stage with respect to the one or more printheads.

4. The method of claim 2, wherein the one or more printheads comprise an array of printheads, and wherein moving the stage with respect to the one or more printheads comprises moving the stage in a line perpendicular to the array of printheads.

5. The method of claim 1, further comprising:
moving the one or more printheads with respect to the stage.

6. The method of claim 5, wherein moving the one or more printheads with respect to the stage comprises one or more of:
moving the one or printheads horizontally, moving the printheads vertically, rotating the printheads, and tilting the printheads with respect to the stage.

7. The method of claim 1, wherein the one or more printheads comprises a plurality of printheads, and wherein the method further comprises introducing different chemical precursors into the plurality of printheads.

8. The method of claim 7, wherein one of the plurality of printheads dispenses the metallic compound comprising an aluminum-based compound, and another of the plurality of printheads dispenses the reactive liquid or gas comprising hydrogen peroxide.

9. The method of claim 1, further comprising:
adjusting a size of an opening of nozzles of the one or more printheads, adjusting the size of the droplets or stream dispensed over the substrate.

10. The method of claim 9, wherein the size of the droplets ranges from 30 μm to 500 μm.

11. The method of claim 1, further comprising curing a layer formed from the dispensed chemical precursors.

12. The method of claim 11, wherein curing the layer comprises irradiating the layer with a UV lamp, heating the substrate with a heater, plasma curing, or electron beam (e-beam) curing.

13. A piezoelectric printhead to deposit a thin film over a semiconductor wafer, the piezoelectric printhead comprising:
a compartment to receive a chemical precursor including one or more of a metallic compound and a reactive liquid or gas;
a nozzle to dispense the chemical precursor, the nozzle having an opening with an adjustable size to dispense droplets of the chemical precursor of different sizes or a continuous stream of the chemical precursor; and
a piezoelectric component coupled with the nozzle to force the chemical precursor from the compartment to the nozzle, dispensing the chemical precursor over a surface of the semiconductor wafer.

14. The piezoelectric printhead of claim 13, wherein the opening of the nozzle is adjustable to dispense the droplets in sizes ranging from 30 μm to 500 μm.

15. The piezoelectric printhead of claim 13, wherein the printhead is disposed on a dispenser arm that moves with respect to a stage over which the printhead is disposed.

16. A system to deposit a thin film over a substrate, the system comprising:
a processing chamber;
a stage to support the substrate in the processing chamber;
one or more piezoelectric printheads to dispense one or more chemical precursors in droplets or a stream over the substrate; and
a chemical precursor source to deliver the one or more chemical precursors including a metallic compound and a reactive liquid or gas to the one or more piezoelectric printheads.

17. The system of claim 16, wherein the stage moves with respect to the one or more printheads, including one or more of: moving horizontally, vertically, rotating, and tilting with respect to the one or more printheads.

18. The system of claim 16, wherein the one or more printheads comprise an array of printheads, and wherein moving the stage with respect to the one or more printheads comprises moving the stage in a line perpendicular to the array of printheads.

19. The system of claim 16, wherein the one or more printheads comprise a plurality of printheads, and wherein one of the plurality of printheads dispenses the metallic compound and another of the plurality of printheads dispenses the reactive liquid or gas.

20. The system of claim 16, further comprising a UV lamp to cure a layer formed by the dispensed chemical precursors.
